(19) United States
(12) Patent Application Publication
(10) Pub. No.: US 2017/0039477 A1
(43) Pub. Date: Feb. 9, 2017

(54) PROBABILISTIC INFERENCES NETWORK UTILIZING SECOND ORDER UNCERTAINTY

(71) Applicant: C. Thomas Savell, Vista, CA (US)

(72) Inventor: C. Thomas Savell, Vista, CA (US)

(21) Appl. No.: 14/821,613

(22) Filed: Aug. 7, 2015

(51) Int. Cl. G06N 5/04; G06N 7/00

(52) U.S. Cl. CPC G06N 5/045; G06N 7/005

(57) ABSTRACT

In an inference engine a conditional dependency of variables is characterized in terms of second order uncertainty to aid in improving decision making speed and precision. Mean and distribution of evidence states are utilized to provide first order uncertainties for each of a plurality of states. Higher order statistics such as standard deviation and variance for the states are calculated in order to define second order uncertainties. A covariance layer of the inference engine receives variance information from parent nodes for calculating the states of a child node. Second order uncertainty expresses conditional dependency of the parameters to which the child node responds. The method and apparatus are generalized to apply the propagation of second order uncertainty through inference engines such as Bayesian Networks, Influence Diagrams and Probabilistic Relational Models, to output control signals.

### FIELD OF THE INVENTION

The present subject matter relates to an inference engine for increasing the expressiveness of Probabilistic Relational Models, Influence Diagrams, Bayesian Networks and the like, using second order probability representation for encoding conditional dependencies.

### BACKGROUND

Probabilistic models are used to inform a human decision in selecting one of a number of possible courses of action in a situation that involves uncertainty and to provide a guide to rational action. A number of techniques have been developed to exploit the capabilities of probabilistic reasoning. These reasoning techniques include Probabilistic Relational Models (PRMs), Influence Diagrams (IDs), Bayesian (aka Belief) Networks (BNs), Markov models, and Monte-Carlo/Latin Cube simulations.

A PRM is the current state of the art technique for creating a statistical prediction system of large and complex problems (domains) containing uncertainty. A PRM is a design architecture used for assembling a diverse set of statistical techniques such as IDs, BNs, Markov models, and a variety of other methods, into a consistent uniform predictive framework.

In contrast, a BN (and its ID extension) for a given domain involves a pre-specified set of random variables, whose relationship to each other is fixed in advance. A BN/ID graphical modeling method lacks the concept of an “object” (also known as domain “entity”). Hence, a BN cannot be used to deal with domains that may include a varying number of similar entities in a variety of configurations applied in multiple contexts. PRMs enhance BNs with the concepts of objects, their properties, and relations between them. In a way, PRMs are to BNs as relational logic is to propositional logic.

A discussion of the prior art is presented in the context of a PRM. For simplicity, the discussion is directed to a PRM composed of IDs and BNs. An ID is a network representation for probabilistic and decision analysis models. Various objects displayed in an ID (called “nodes”) correspond to variables which can be constants, uncertain quantities, utilities, decisions or objectives. A subset of an ID is a BN which is a graphical model of the likelihood of a hypothesis occurring in a child node based on a-priori evidence provided by its parent nodes. The nodes of a BN are called “Chance Nodes.” Detailed data about the variables are stored as finite states within each node. The likelihood of the hypothesis occurring in a BN child node is expressed by Bayes Theorem, which is encapsulated by coefficients populated in a Conditional Probability Table (CPT) expressing the statistical outcome of the expressed states of a child node as a function of the states of its various parent nodes. The PRM diagram illustrates the relationship between the nodes and provides a basis for determining the information needed to establish a hypothesis, that is, to make a decision. The complete ID adds two additional node types to the BN Chance node: Utility nodes and Decision nodes. Utility nodes provide a value associated with a decision typically expressed in terms of money, time, safety or quality. Decision nodes are discrete output from the network resulting in an expressed Course of Action (COA) based on the decision. Multiple COAs are possible based on the persona of the decision maker. That is a unique decision having one of numerous possible outcomes.

The “hypothesis” associated with the output of a BN inferred at the child node refers to a set of values indicative of a set of parameters on which a decision will be based. Generally, prior art methods have processed only one hypothesis at a time. Each individual result based on one hypothesis is provided without regard to its precision relative to other hypotheses. Generally, the first hypothesis uses a single value for each state of a parameter that is the mean of a statistical distribution of expected values for that parameter. In order to provide results over a range of parameter values, a new calculation must be performed for each set of values.

Node values may be deterministic, i.e., a single state with probability of 100%, or probabilistic, i.e., having a likelihood distribution across a number of states with different likelihoods having a cumulative sum of 100%.

Uncertainty in a BN is described by the distribution of the states in the evidence held by the individual nodes and in the uncertainty set in the CPT coefficients. The extension of a BN to an ID adds the possibility of uncertainty in the prescribed utility table associated with the utility nodes. The use of PRMs introduces the possibility of considering an additional form of uncertainty called “Structural Uncertainty,” which cannot be captured with a standard BN/ID. PRM' s Structural Uncertainty in the interconnected models includes: 1) Number uncertainty—uncertainty about the number of entities elsewhere in the PRM (as found in different classes) to which a particular entity is related; 2) Reference uncertainty—uncertainty about the identity of the other entities in the PRM to which a given entity is related; and 3) Existence uncertainty—uncertainty as to whether a proposed entity elsewhere in the PRM, which has the potential of existing, actually exists.

U.S. Pat. No. 6,807,537 discloses a method of operating a decision support system comprising a BN having a plurality of nodes. Each node is associated with parameters expressing prior probabilities. A subset of the parameters stores a value range. A set of probabilities of interest is calculated based on the parameters. This technique uses a highly limited range of parameter probability values and assumes that value distribution is uniform within that range. This set provides for a highly constrained set of hypotheses that still provides limited information as to relative precision.

The probability distribution of the mean likelihood expressed across the number of possible states for a variable is called First Order Uncertainty (FOU). FOU methods utilize a fixed value for each state associated with a given variable. In many applications FOU inferences lack precision resulting in insufficient accuracy to determine a concise decision. To gain the necessary additional precision in the inference and resulting decision, a Second Order Uncertainty (SOU) distribution of the states is needed. SOU determines the probabilistic uncertainty about the likelihood of any given state within an FOU state distribution.

The current state of the art for establishing the SOU for each variable inherent in the network is to perform a Monte-Carlo/Latin Cube simulation on the PRM (and/or its subcomponent BNs/IDs). The Monte-Carlo simulation however is a time consuming multi-step process involving: 1) establishing the probability distribution of each state defining the evidence provided to the BN input variables, 2) preforming a randomized selection of a unique value of the evidence of each state of each input variable from its distribution, 3) executing the BN to its inference hypothesis, 4) expressing a decision based on the hypothesis, 5) calculating the utility associated with the decision and likelihoods directly influencing the decision node, 6) calculating the multitude of alternative COAs, and 6) choosing the optimal COA. The process is iteratively repeated typically tens of thousands of times to produce a precise distribution of the inferred outcome. This precise distribution is then used to arrive at a decision and corresponding COA with higher confidence. The Monte-Carlo/Latin Cube simulation approach is a satisfactory approach for domain problems that are not time constrained. For time-critical domains requiring high precision an alternative approach is needed.

A number of approximate methods have been developed in an attempt to provide the necessary precision at high speed. The most popular of these approximate methods is the Dempster-Shafer (D-S) theory (also called “interval propagation) based on belief functions and plausible reasoning. It is used to combine separate pieces of information, or evidence, to calculate the probability of an event. Uncertainty of a proposition is expressed in terms of confidence intervals. The lower bound of the confidence interval is the belief confidence, which accounts for all evidence, Eₖ, that supports a given proposition “A.” An upper bound of the confidence interval is plausibility confidence, which accounts for all the observations that do not rule out the given proposition A. The limitations of D-S have been criticized openly in the literature. A basic reference work in the area of FOU is J. Pearl, Probabilistic Reasoning in Intelligent Systems, Morgan Kaufman Publishers, San Francisco, 1988. Pearl indicates in page 350 of his work that: “the D-S theory fails to capture the obvious lack of confidence in the judgement”; and that “the belief intervals encoded in D-S theory have a totally different semantics than the confidence measures portrayed by [probability theory.]” Pearl further explains on page 421 of his work that “the D-S theory differs from probability theory in several aspects” which he outlines there. He explains the disparity between the Bayesian formalism and D-S as the Bayesian “approach interprets “belief in A” to mean the conditional probability that A is true, given the evidence, e, the D-S approach calculates the probability that the proposition A is provable given the evidence, e, and given that e is consistent. As a result D-S lacks the flexibility to accommodate partial information in the network since the uncertainty about probabilities is not represented in D-S formalism. Other critics of the approximate methods to capture SOU include: Hoffman and Murphy “Comparison of Bayesian and Dempster-Shafer Theory for Sensing: A Practitioner's Approach (1993)” and Baker “How is Dempster-Shafer theory different from the Bayesian approach?”

The present application is concerned with a method for calculating precise SOU in PRMs, IDs and BNs which is consistent with Bayes Theorem at several orders of magnitude faster than that achieved with traditional Monte Carlo/Latin Cube simulations and with much higher confidence than that achieved with alternative prior art methods claimed to calculate SOU at high speed.

For emphasis it is restated that prior art methods for capturing SOU consistent with Bayes Theorem have utilized sampling the likelihood of all possible values within each state for each variable in the FOU network. In order to examine the results of the relationship between the variables over a range of SOU probabilistic values, prior art methods have had to conduct repeated analyses for each of a set of the possible FOU values within a subset of the probabilistic range. Performing a large number of sets of computations using techniques such as Monte-Carlo or Latin Cube simulation is time-consuming, requiring thousands of iterations across the probabilistic ranges of possible FOU values within individual nodes representing the variables describing the decision making problem. With current processing resources, a nominal problem could take an extended period of time to solve, rendering such prior art methods useless in situations in which a result needed to make a decision must be made quickly. Such decisions include whether data received on a sensing system is indicative of a military attack, whether a flash flood is about to occur or other situations requiring virtually immediate action.

United States Patent Application Publication No. 2015/0019241 discloses a system and method of providing decision support for assisting medical treatment decision-making. An optimal treatment is determined by evaluating the plurality of decision-outcome nodes to output the optimal treatment. When additional information is available from at least one of a patient agent and a doctor agent, filtering, creating and determining steps are repeated thus allowing for the system to “reason over time.” This system is intended where medical treatment decision making is not time-critical. In contrast, the present subject matter is useful for applications such as robot-assisted surgery, where time is of the essence.

United States Patent Application Publication No. 2009/0313204 deals with sampling-based robust inference for decision support systems (DSS). The system comprises at least one BN comprising a plurality of nodes, each node being associated with parameters expressing prior probabilities. At least a subset of the parameters stores a value range, and a set of probabilities of interest are calculated based on the parameters using a standard inference algorithm. Each value range represents an uncertainty associated with the corresponding parameter. This technique requires painstaking sampling. Narrow intervals can propagate into wide intervals which are not informative in the decision making process.

Some shortcomings of the prior art have been overcome by a system produced by GCAS, Inc. of San Marcos Calif.

### SUMMARY

In accordance with the present subject matter, a system is provided in which the expressiveness of PRMs, IDs, BNs or other first order uncertainty inference networks is increased by using second order probability representation for encoding conditional dependencies among variables. The precision is increased with respect to systems accounting only for first order uncertainty, and the speed is significantly increased over the state of the art methods to increase precision.

In one form, a method encodes conditional dependencies in an inference engine comprising a network and embodying a mathematical model representing a context in which statistical methods are used as an aid in decision making in which uncertainties are propagated between one level and a next level. The method comprises receiving evidence inputs at a parent node, resolving each input into states, calculating first order uncertainty of states for a given evidence input, and calculating higher order statistics, including standard deviation and covariance for the states, whereby a second order uncertainty is provided.

In one form, the system utilizes a PRM having nodes (attributes) from IDs, and BNs as substructure classes of the PRM within the system. The nodes may comprise Chance nodes providing information about the parameters, utility nodes and decision nodes. The information could include sensor data. At the data inputs, both a mean and higher order statistics, such as standard deviation, are calculated. The second order uncertainty, represented by the higher order statistics, including standard deviation) found in the Chance nodes. The CPT values connecting the Chance nodes are propagated through decision and utility nodes. The utility table associated with utility nodes may also be a source of SOU.

The method and system are generalized to operate in a PRM, BN, ID, or a control circuit.

### BRIEF DESCRIPTION OF THE DRAWINGS

The present subject matter may be further understood by reference to the following description taken in connection with the following drawings:

FIG. 1 is an illustration of a scenario in which probabilistic inference is used as an aid in human decision-making in a-time critical application;

FIG. 2 is an assembly of Probabilistic Relational Models (PRMs) comprising a mathematical model characterizing factors in a decision to be made;

FIG. 3 is an Influence Diagram (ID) found as an entity in a PRMO;

FIG. 4 is a Bayesian Network (BN) found as an entity in a PRM1;

FIG. 5 is a CPT Snippet for the PRM1 “Wind Opportunity” Chance Node of FIG. 4;

FIG. 6 is an architecture diagram of the present system;

FIG. 7 is a functional block diagram corresponding to the architecture diagram of FIG. 6;

FIG. 8 illustrates a Gaussian distribution;

FIG. 9 is a block diagram of the process in one form of the present system;

FIG. 10 is a block diagram illustrating further details of the system of FIG. 9;

FIG. 11 is a flow diagram of the process performed in the system of FIG. 9; and

FIG. 12 is an SOU model illustrating a comparison among Monte Carlo exact method, Dempster-Shaffer interval-based propagation, and SOU mean/covariance propagation.

### DETAILED DESCRIPTION

In accordance with the present subject matter, a probabilistic reasoning network is provided in which second order uncertainty is accounted for in computations. The network utilizes a decision algorithm which propagates both means and covariances to provide a result having the highest confidence with the least data, thereby avoiding the need for painstaking sampling. An uncertainty inference engine provides both mean and variance data to a decision algorithm. A statistical distribution within each state is used to account for second order uncertainty.

PRMs, IDs, BNs described below (or other tools) are used for decision making in the presence of uncertainty. Individual parameters, e.g., measured values, are usually taken to be fixed and well defined. However, each value has an uncertainty associated with it. This is first order uncertainty (FOU). A problem is modeled as a probabilistic relationship between uncertain or random variables that represent the events that characterize the problem. There is a probability that an event with respect to one parameter will cause other events with respect to another parameter. This is a conditional probability.

“Second order uncertainty” (SOU) is the uncertainty in the assigned likelihood value of a given state in a FOU state distribution of a given variable (i.e., node) in the network; and/or in values defined in the Conditional Probability Table (CPT) rules describing the a priori Bayesian relationship between the parent and its children variables connecting the nodes in a BN, entities in an assembly of PRMs; or in the utility table of an ID. SOU is the uncertainty within the uncertainty.

The confidence in inferences made by a BN/PRM depends on how well the parameters assigned to each node match reality. These parameters are often hard to establish with high precision, so each parameter has an inherent uncertainty. The uncertainties of all parameters involved in the inference propagate to the output probabilities, cause uncertainty about the numbers that the BN/PRM provides to the user or to any subsystem that uses these output probabilities. Establishing these uncertainties in the probabilities of interest is called robust inference. In accordance with the present subject matter, techniques are refined using SOU for increasing the precision and speed of the decision making.

Particular contexts in which the present subject matter solves the long-standing technological problem of limitations in the precision of first order uncertainty inference engines include the BN, ID and PRM. In the PRM/BN uncertainties exist in the values of parameters and coefficients of the CPT connecting the parameters. The ID uses interaction of nodes, e.g., Chance nodes providing data propagated by embodied BNs, utility and decision nodes to evaluate preferability of different available courses of action. In addition to the second order effects in the Chance nodes, utility values in the ID utility table can have a second order distribution. The completed ID is defined to be a “model.” First order uncertainties exist in the propagation of probabilities through the nodes in the model.

The PRM is an architectural scheme for utilizing relationships, arranging, ordering and connecting an assembly of diverse models. PRMs have inherited terminology from Relational Databases and Object Oriented Programming such that the individual statistical models of objects in the assembly are called “classes.” The entities, i.e., the node objects, in a given model are called “attributes” of the class, and the connections between the objects in different classes are called relationships. A PRM interconnects all these models as a system, and relations interconnecting the various models have an additional form of uncertainty associated with the modeling architecture called “structural uncertainty.” In particular three types of structural uncertainty may exist, namely number, reference and existence uncertainty.

However, each first order uncertainty has its own uncertainty. The present subject matter produces a second order uncertainty, which is the uncertainty of the first order uncertainty. Second order probability representation is used for encoding conditional dependencies among variables. Precision of the system output information is increased. Prior art methods of reducing effects of first order uncertainties, some of which are computationally intensive, need not be used.

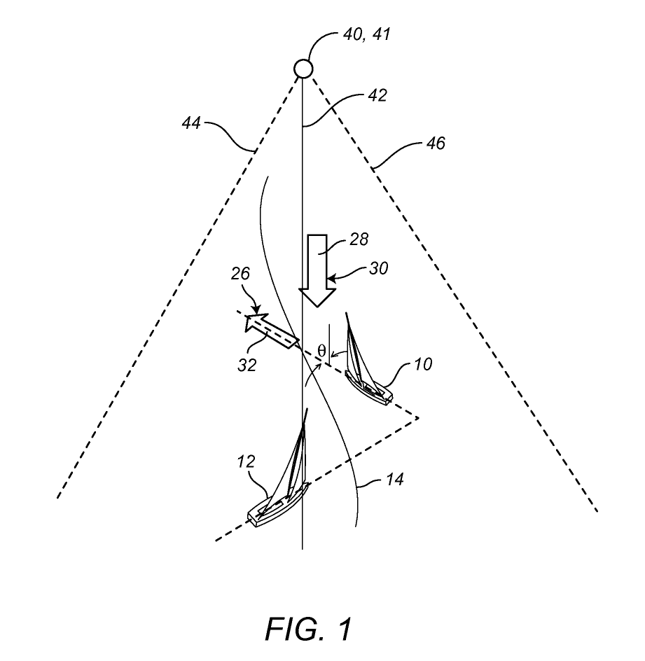

FIG. 1 is an illustration of a scenario in which probabilistic inference is used as an aid in human decision-making in a time-critical application. This scenario relates to operation of a sailing yacht in a competition where quick, precise decisions are needed, such as the America's Cup race. Decision making using probabilistic inference can result in any number of scenarios and Courses of Action (COAs) as characterized by the parameters selected for processing, one of which will be selected by a captain.

Racing teams make enormous financial and emotional investments in participating in the race. The stakes for the outcome are extremely high. The difference between outcomes that the teams regard as success, winning, or failure, losing, is the composite result of a very large number of decisions, many of which have to be made quickly. Precision in the information used in making decisions seriously affects the quality of outcomes. A decision aid that operates quickly and reliably is essential. The present subject matter can aid in rapidly making each decision. Decisions are made in the context of interrelationship of parameters affecting the outcome.

In the present illustration a yacht 10 is racing against a yacht 12 on a course 14 towards a mark 40 in a variable wind. The heading 42 towards a finish line mark 41is generally constrained by laylines 44 and 46, which are estimated by yacht captain. A layline is a straight line (or bearing) extending from the next mark to indicate the course a boat should be able to sail on the one tack in order to pass to the windward side of the mark. The angle between the laylines 44 and 46 can be as large as 45 degrees in amateur sailing but for highly skilled America's cup, the angle is more like 30 degrees. Sailing beyond the layline will result in losing position in the race. It is a general tactic to tack as few times as possible.

The overall performance, or “utility,” of the yacht 10 is measured by the total time it takes to complete the course 14. Many different parameters must be accounted for including separation between the boats, when to tack and the estimated layline, which is function of the wind conditions and tide. Each parameter has its own degree of uncertainty in terms of predicting its contribution to the overall result and represents a risk factor during the race. The overall tactical objective in the race is to sail the course in the least distance which normally results in the shortest time. This mainly implies staying within the laylines, which shift with the wind, and avoiding losing distance to the opponent via a wind shift.

Parameters impacting the inference include: the relative position of the yacht relative to its competitors in the race, separation, an angle θ of the yacht 10 with respect to the wind 30; direction 26 of movement of the yacht 10; velocity 28 of the wind 30; and yacht 10's velocity 32. Dozens of parameters may be characterized for operation of the yacht 10. Separate models may include a synopsis of the current position of yacht 10 and 12 and other competitors in the race, and a model of what the decision maker feels yacht 12's captain and other competitors' tactical maneuvers might be. A PRM interconnects all these models as a system and relations interconnecting the various models have structural uncertainty. The number of parameters considered here is limited for purposes of illustration. In the broader context of decision making to achieve the optimal utility and corresponding course of action, decisions are influenced by the persona of the decision maker.

In accordance with the present subject matter, second order probability representation is used for encoding conditional dependencies among variables. This increases the expressiveness of the data provided by such First Order Uncertainty Networks as BNs.

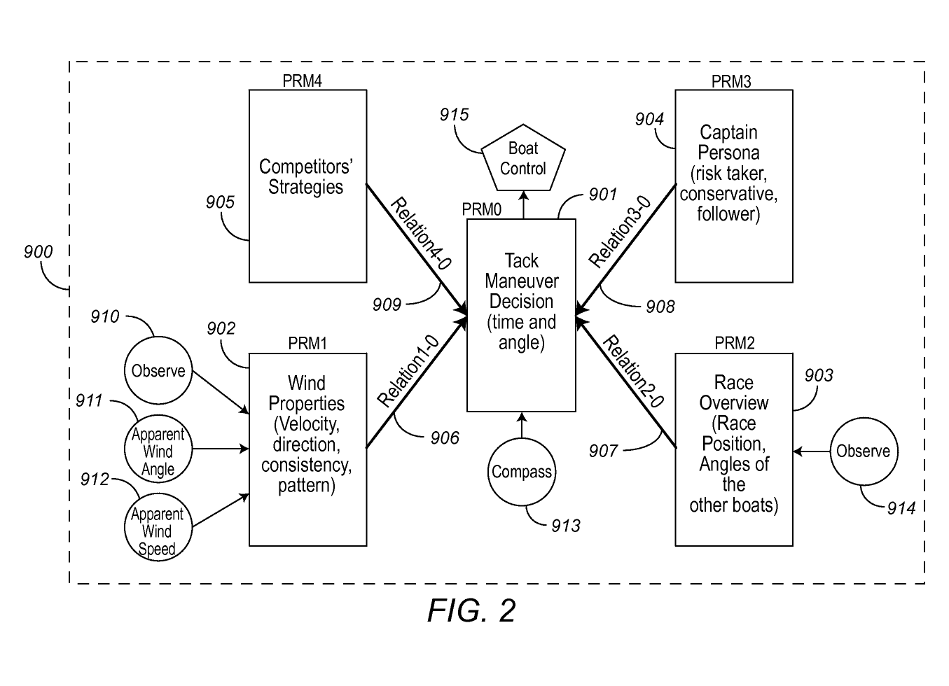

A first example is illustrated in FIG. 2 as an assembly 900 of five PRMs 901-905, shown at a single snapshot in time, i.e., within a defined window, comprised of a variety of independent statistical models, e.g., BNs and IDs, representing the real-time decision making that is required in the sail boat race example. Since the sailboat race is a time varying event, a dynamic model is required meaning that duplicate PRMs are needed at a minimum of two additional time points for each of the three time varying models PRMO-PRM2. Therefore the full model has at least 11 PRMs. The recursive feature of PRMs is used to model the changing time over the simulation.

The various PRMs are connected by arcs defining the relations that exist between models. The relations contain the normal uncertainty found in BNs and IDs. Of the three unique forms of additional uncertainty possible with PRM relations, i.e., number, reference and existence, only reference uncertainty is possible in the sailboat application. Indeed reference uncertainty does frequently occur in competitive races and is termed “having your head in the boat,” meaning the captain has lost track of his competitor's status and maneuvers at any point in time during the race. Indeed in high level competition such as the America's Cup, a crew member is specifically assigned to prioritize and advise the skipper throughout the race. The five PRMs model contain the following information:

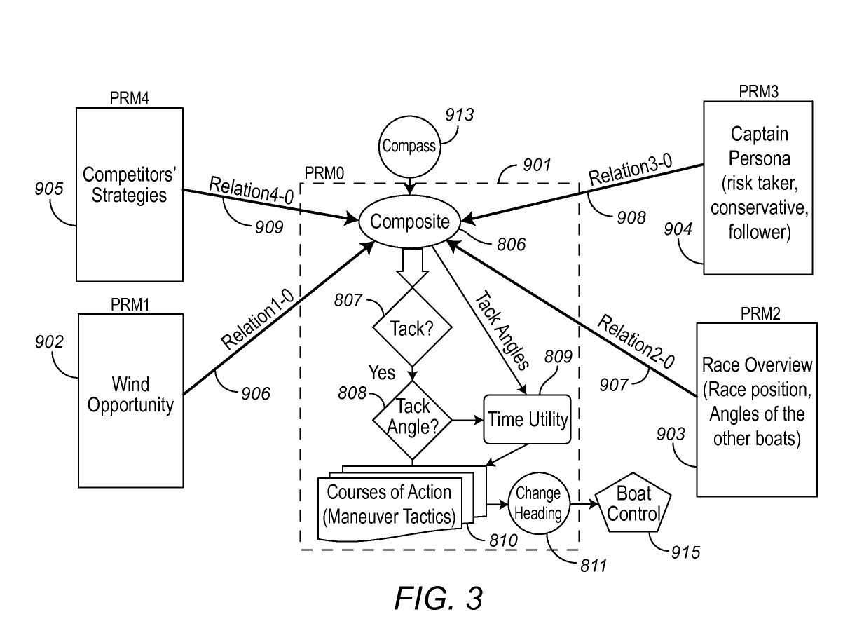

PRMO 901 comprises a mathematical model of the factors that are considered in making a decision and choosing the optimal course of action (COA) for yacht 10 as represented by the ID in FIG. 3. It contains an ID for when to tack and at what angle. A real-time external input to this PRM is the boat compass 913 data, which is used to provide information when racing to an upwind mark. If at any time there is a compass heading shift, if the shift is oscillating the captain will “tack now.” If the compass shift is persistent, then the captain will keep going on along the current heading. The optimal COA is selected and the new heading as determined by a deterministic node in PRMO that outputs a unique digital value for the unique tacking angle to boat controller 915.

PRM1 902 contains BNs for determining the wind properties such as velocity, direction, consistency and pattern from ship-board sensor inputs 911 and 912 and observation 910 at a single snapshot in time.

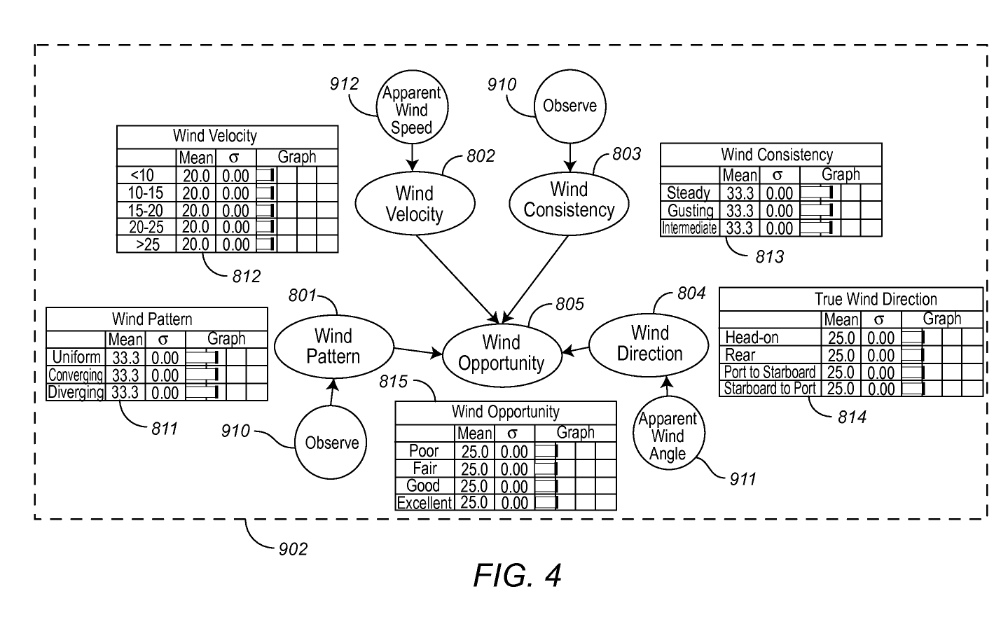

FIG. 4 is a high-level schematic representation of the BN structure in PRM1. PRM2 903 (FIG. 2) contains BNs for the real-time race overview such as the boat's current position in the race and the current position and traversing angles of the other boats, all obtained from observation 914 (FIG. 2).

PRM3 904 contains an agent-based ID which captures the persona of the boat captain as needed for the real-time decision making, utility calculation and optimization of the family of COAs provided as outputs by the network. This agent is a static object which does not change with time and has been established prior to the beginning of the race. PRM4 905 consists of various agents and IDs that are models of the expected behavior and strategies to be carried out by all the other boats in the race, one agent for each boat. This PRM has been established prior to the beginning of the race.

The relations connecting the various PRMs 906-909 connect attribute nodes in each parent PRM 902-905 to the child Tack Maneuver Decision PRM 901. Relation 907 may also have a relation associated with reference uncertainty which is unique to PRMs. Note that not all the possible relations are shown in the diagram. Also note that for purposes of the present illustration, a limited number of factors are represented. A full representation would be quite complex.

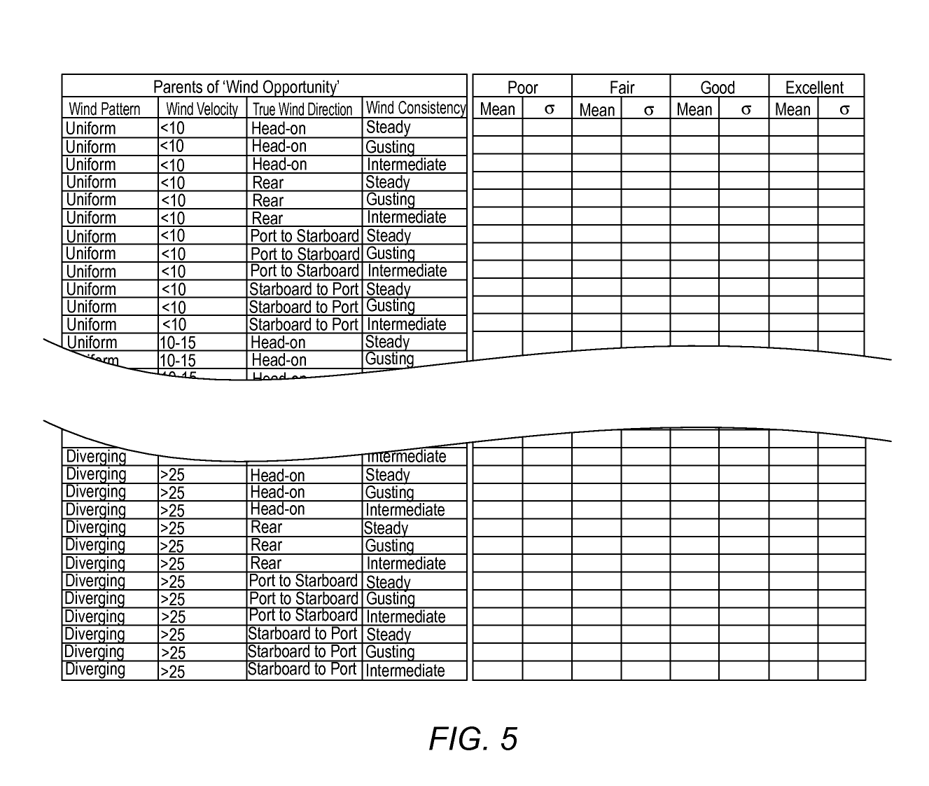

Probabilities are propagated in BNs and IDs as inference between the parent nodes and a given child node using Bayes Theorem encoded through a Conditional Probability Table (CPT). The coefficients populating each cell of the table provide the likelihood that a child state will be achieved given all the state conditions for which the parents may exist. The size of the child CPT table is a product of the states of the parents by two times the number of states of the child and can be a fairly large array. For example, the full CPT partially shown in FIG. 5for the “Wind Opportunity” child node of FIG. 4, has 1440 values as represented by the states populated in 3×5×3×4, or 180, parent state row combinations, and 8 columns (FOU mean value and SOU higher order statistics such as standard deviation for the four possible outcome states).

In the present illustration, the decision at hand presented in PRMO (FIG. 3) is whether or not to tack at a particular time. Once a decision is made to tack, a further decision as to what angle should be taken is also made. Tacking comprises changing the angular displacement of the yacht with respect to the wind 30 from an angle having a positive value to an angle having a negative value where the wind is considered to be coming from a direction of 0°. The utility in FIG. 3 used as a measure for the decision making is the time that will be taken for the yacht 10 to traverse a particular distance.

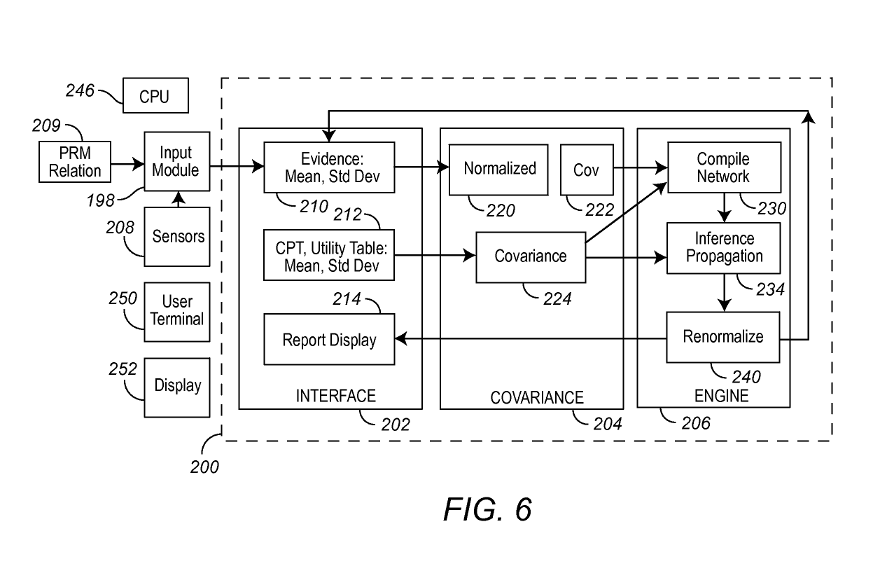

FIG. 6 is an architecture diagram of a processing engine 200. The processing engine 200 may be viewed as comprising three sections. For the purposes of description they are referred to as an interface layer 202, covariance layer 204 and an engine layer 206. The interface layer 202 interfaces the system with the outside world data input modules 198 receiving inputs from sensors 208 or from relations established with associated PRMs 209. An evidence module 210, representing the group of primary parent nodes of the network, receives inputs from sensors 208 via the input modules 198, which provides the mean and variance values for the evidence states in module 210. A CPT module 212 provides mean and variance value for the Conditional Probability, i.e., Bayesian rules embodied in the CPTs of Chance nodes and Utility values for Utility Nodes. The rules provide the relationships between the various parent nodes to a given child node represented in the network. A multitude of CPT modules exists, one for each child node in the network. The values in the CPTs can have SOU as well, so each combination of possible parent states have both a mean value and higher order statistics such as standard deviation as shown in FIG. 5.

A report and display module 214 provides reports and displays results to a user in terms of the inference distribution across states. In the covariance layer 204, evidence from the evidence module 210 for each parent node is normalized for processing within the data normalization module 220. The normalization module 220 provides an input to an evidence covariance module 222 which creates covariances from an array of variances. Additionally, a CPT covariance module 224 receives inputs from the CPT module 212. In the engine layer 206, a compile network module 230 receives inputs from the evidence covariance module 222. The covariance CPT module 224 also creates covariances and provides inputs to the compile network module 230. The compile network module 230 processes the inputs. The outputs from the compile network module 230 are assembled in the inference propagation module 234 and are re-normalized by a re-normalization module 240 to provide inputs suitable for translation by the report and display module 214. This process produces evidence in terms of the mean and covariance of the possible states for the child node, which subsequently becomes the parent to all child nodes connected to it. The evidence module 210 is then recursively deployed starting the above described process over again for each of the children nodes. This entire process is recursively performed until all nodes within the network are executed.

The processing of relations from associated Probabilistic Relational Models (PRMs) is conducted in a similar way to inputting evidence in a standard BN. As described previously, the PRM combines advantages of relational logic and BNs.

While the process diagram FIG. 6 represents a BN with PRMs, it is analogous to and also represents using the present subject matter in IDs, PRMs and imbedded deterministic nodes as output to a control system. In an ID such as FIG. 3, probabilistic Chance nodes may comprise Bayesian Networks and second order uncertainty is propagated via contributions of parent nodes to child nodes as described in FIG. 3 as well as the utility table associated with the utility node.

In the case of PRMs, BNs, IDs, and other statistical methods are used as building blocks to embody the PRM. The uncertainty which is accounted for is the relationship between IDs that interact with each other. The compile network module 230 for IDs contains additional algorithms for the processing of utility. The evidence from Chance nodes are combined with the utility table values to produce the range of expected utility for a selected course of action (COA), established by the decision node. A family of COAs is generated for evaluation in view of the persona of the decision maker.

The second order uncertainty is propagated via the composite result of each of the interactions between one ID and a next ID or IDs. For purposes of the present description, the term inference engine in which uncertainties are propagated between one level and a next level is used to describe Bayesian Networks, IDs and PRMs.

The present subject matter is also used in conjunction with deterministic nodes found embedded in the network. Deterministic nodes have a probability of 100% and can be used to represent a control output. For example, the output would be a control signal 915 (FIG. 3) to the sails in FIG. 2, thereby automatically changing direction. In this regard a complete control system is provided. The purpose of compilation is to reorganize the network in a manner that inference can be performed in a consistent fashion. In the present illustration, an inference diagram is utilized to characterize the network. Many alternative approaches could be used. These include the PRM-, Junction Tree, Clique Tree, Parametric Inference, Monte Carlo/Latin Cube Sampling, Vertex Elimination, Cutset Conditioning and Loopy Propagation. These approaches are alternatives which can be used to comprise the compile network 230.

The evidence module 210 in the interface layer 202 propagates mean and variance values for evidence received from outside inputs, PRM relations, or connected parent nodes in the network. The standard prior art inference that is performed in conventional BNs, IDs and PRMs is FOU. In accordance with the present subject matter, SOU inference is deployed where mean values and covariances of the potentials are combined to obtain covariances of the resulting potential. Covariance potentials are symmetric. The evidence is normalized by the evidence normalization module 220 to be in a form for manipulation by the covariance module 222.

The renormalization module 240, in accordance with the present subject matter, normalizes both the mean values and variances of the results using mean values and covariances computed during propagation. This step ensures that the variances remain bounded. Re-normalizing covariances avoids the problem of erroneous variance values being further magnified with successive calculations. Operations are commanded from a CPU 246. A user terminal 250 including a display 252 is coupled to the processing engine 200. The data provided by the module 214 is the decision aiding data.

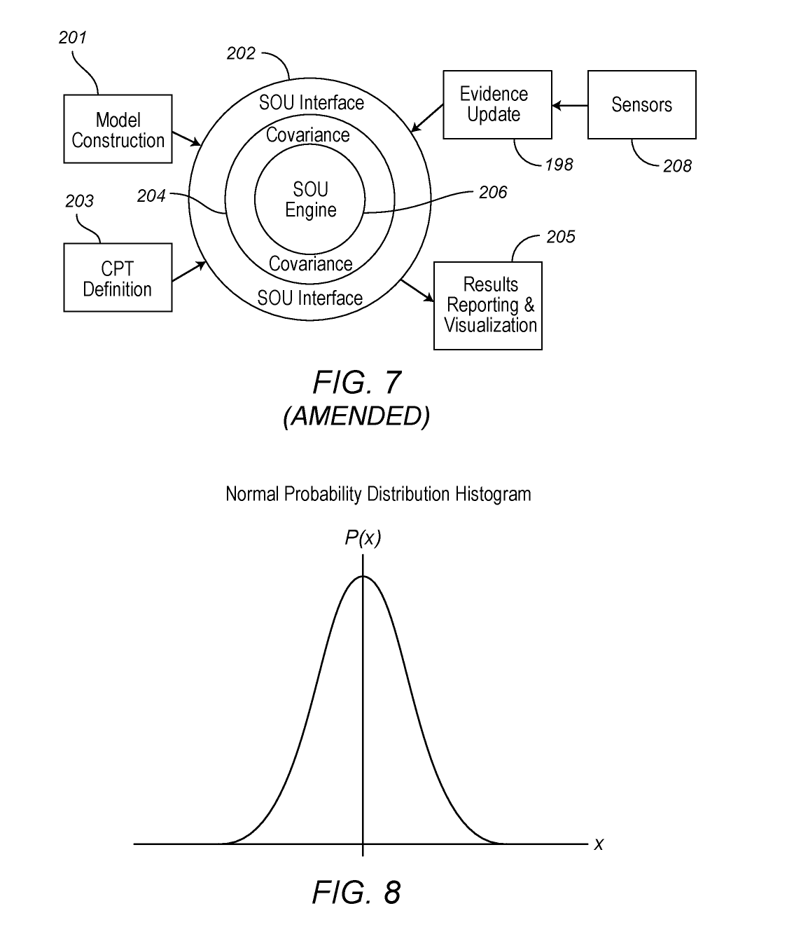

FIG. 7 is a functional block diagram corresponding to the architecture diagram of FIG. 6. The engine layer 206 is represented at the center of the process. Processing steps in the engine layer 206 are substantially exact. In the covariance layer 204 real-time evidence from the sensors 208 is formatted and manipulated so that it is compatible with the compile network 230 (FIG. 6). A set of parameters called covariances is calculated for use in providing a probability result. The interface layer 202 is the layer seen by a human user for creating a model of the phenomenon under study. This layer provides the rules associated with relationships between the various parameters and variables in the model, providing evidence which comes from the outside and displaying the results of a probabilistic inference. At the interface layer 202, approximations may be introduced to allow results within a given state to be represented by probability distributions most frequently found in nature, such as the Gaussian distribution in FIG. 8 where the distribution can be characterized by just two statistical parameters, mean and standard deviation. Higher order approximations can also be used without loss of generality. In selected unusual and complex problems, approximations may not be appropriate. In this case, approximations can be removed so as not to compromise the accuracy of the engine layer 206. Using an approximate distribution however generally has the advantages of higher computational speed and less memory utilization. Indeed in accordance with the present subject matter, the process of approximating is refined to minimize the effect on accuracy.

Operation of the covariance layer 204 is described in further detail here. A first function performed by the covariance layer 204 is normalizing the evidence. Evidence comprises real-time information from sensors 208 or information entered through other means. The input values are typically expressed in terms of units associated with a respective sensor 208. Sensors 208, for example, may provide output in terms of volts or pulse streams. In one preferred form, parameters are normalized to produce dimensionless values ranging between 0 and 1. Alternatively, the process can be performed without normalizing mean values of variances of the evidence.

Another function of the covariance layer 204 is the specification and calculation of covariances from the variances associated with the CPTs and external evidence provided from the interface layer 202. For simple normal distributions, the variances comprise the cross product of variances which assuming independent measurements, is the square of the standard deviation for a particular measurement. Symmetry in the covariance table is exploited. Zero entries are discarded. This step reduces memory requirements and increases the computational speed. This also assists in providing a way to compute covariances from higher order statistics such as standard deviations. This ensures that covariances can always be computed and that they can preserve fundamental properties that relate to proper representation of CPTs within Second Order Uncertainty (SOU).

The interface layer will define relationships and provide values. More specifically, a detailed structure of the model of the phenomenon being decided is entered. The model includes nodes, or attributes, of the model and associations between nodes represented with arcs and relations. Also stored are the probabilities, i.e., the mean values and standard deviations when using Gaussian distributions for the relationships specified in the CPTs. Mean values and higher order statistics such as standard deviations of evidence obtained from sensors 208 or other interfaces are also defined. Higher order statistics can also be included for more complex distributions without compromising the method to increase the precision of the inference, but at the expense of longer computational time and more memory. In this manner all the information necessary for decision assistance is provided efficiently.

The present SOU method is independent of the type of statistical distribution of observations. A preferable distribution is the normal, or Gaussian, distribution normally encountered in nature. In conjunction with a normal distribution, the mean and higher order statistics such as standard deviation of the mean evidence and CPTs are used in computation, facilitating a fast response.

FIG. 8 illustrates a Gaussian distribution. This function defines the probability that any real observation will fall between any two real limits or real numbers, as the curve approaches zero on either side. The distribution of a variable is a description of the relative numbers of times each possible outcome will occur in a number of trials. The function describing the probability that a given value will occur is called the probability density function (PDF).

Normal distributions are often used in the natural and social sciences for real-valued random variables whose distributions are not known. The normal distribution embodies the central limit theorem. In a wide range of circumstances, the mean of many random variables independently drawn from the same distribution is distributed approximately normally, irrespective of the form of the original distribution. Physical quantities that are expected to be the sum of many independent processes often have a distribution very close to the normal. One such process is first order uncertainty, e.g., measurement errors. Normal distribution of relevant variables allows analytical derivation of propagation of uncertainty and least squares parameter fitting.

Selecting a distribution most closely approximating a particular scenario minimizes the effect of approximations in the generation of a result. Therefore, the use of various distributions for approximation improves the speed and accuracy of the present system.

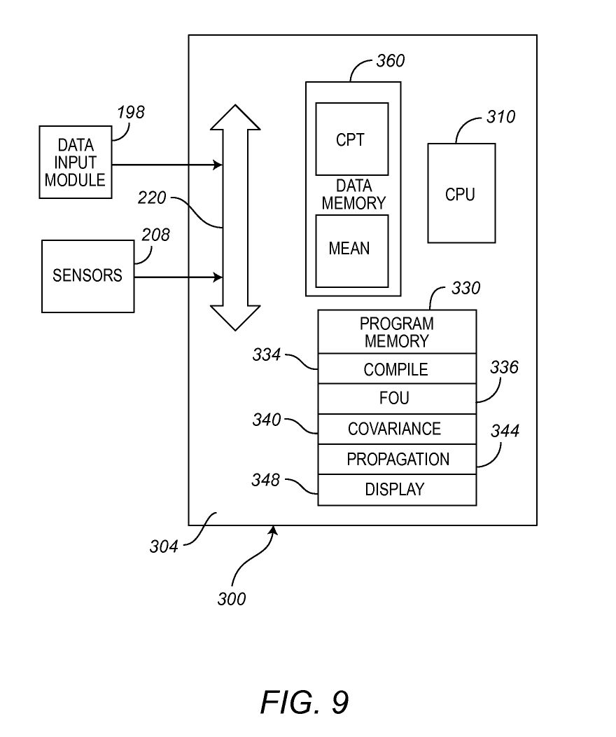

FIG. 9 is a block diagram of the hardware for generating a basic second order uncertainty output. The illustration of a plurality of discrete components is for purposes of simplicity in description. The entire circuit could be embodied in one integrated circuit or could be distributed over many locations. A system 300 corresponds to the processing engine 200 of FIG. 6. The system 300 comprises a processor 304 including a CPU 310 for coordinating and performing operations. A data bus 220 interfaces the system 300 to the outside world. Sensors 208 and the data input module 198 communicate with the system 300 via the data bus 220. A program memory 330 stores routines which are invoked by the CPU 310. Programs include compilation program 334 for organizing the network to perform the probability calculation process, first order uncertainty program (FOU) 336, covariance program 340, algorithm propagation program 344 and display program 348. A data memory 360 stores data relating to the means and to the CPTs.

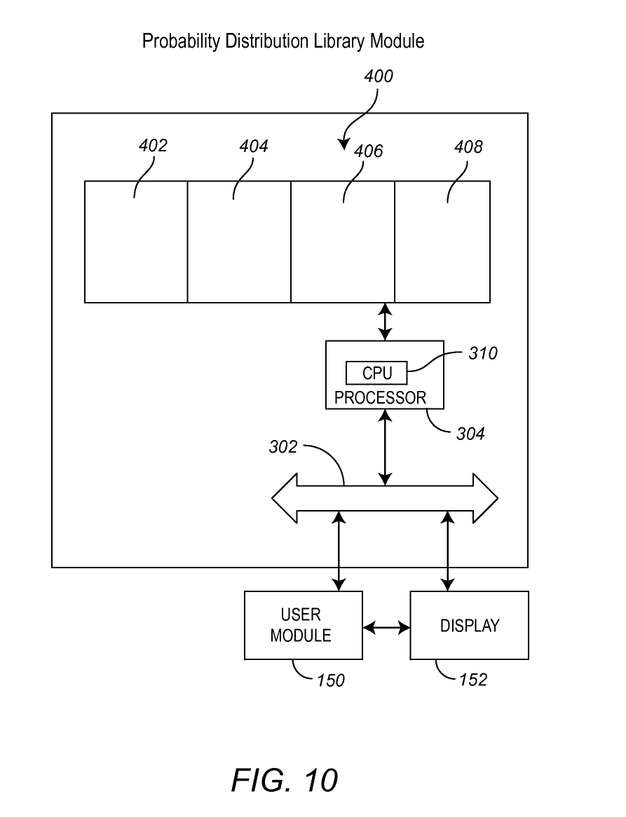

FIG. 10 is a block diagram illustrating further details of the system of FIG. 9. In another embodiment, the data memory 360 (FIG. 9) further comprises a distribution library 400. The distribution library 400 may include a data location for each distribution that is utilized. For simplicity in description, four data locations are shown. In the present embodiment, a first data location 402 stores the mean and standard deviation statistics for a normal, or Gaussian, distribution. A second data location 404 stores the statistics for a statistical distribution defined by Benford's law. A third data location 406 stores the statistics for a hypergeometric distribution. A fourth data location 408 stores the statistics for a Bernoulli distribution. Additional distributions can also be represented. The distribution which is to be used in constructing an approximation may be selected using the user terminal 250 (FIG. 6) or CPU 310. In this embodiment, additional variables are provided at input so that a selected type of distributions other than normal may be assumed and the additional statistics used to represent these distributions are used for presentation throughout the network. Furthermore, different distributions can be used for different evidence or CPT states within the same BN, ID or PRM.

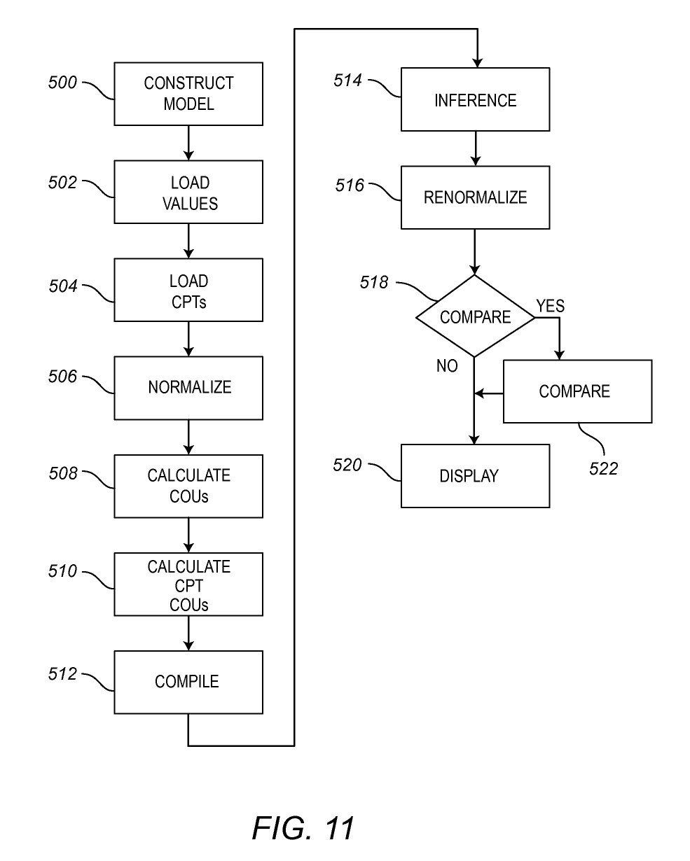

FIG. 11 is a flow diagram of the process performed in the system of FIG. 9. Operation begins at block 500. The steps need not be in the order illustrated unless logically impossible or inconsistent with the operations described above. Steps, such as loading values, may in many cases be done in parallel. The probability to be calculated has been characterized in any of the manners described above. For example, in a Bayesian Network nodes are characterized in terms of parent nodes, child nodes and independent nodes.

At block 502, mean values, variance values and higher order statistics are entered for an initial set of evidence variables and CPTs and mean and variance values for the CPTs are entered into memory. At block 504 a particular distribution is selected for use in approximating inputs and is loaded from the distribution library 400 (FIG. 10). Evidence data is normalized at block 506. Covariance data is created at block 508. At block 510, covariances are created from the CPT variances. The CPT covariance values are transmitted to the compile network 234 (FIG. 4) at block 512. At block 514, the inference propagation module 230 receives the probabilities from the compile network 234 and the evidence covariance module 222 to provide a result which accounts for second order uncertainty. At block 516, results may be normalized for provision to the report and display module 214 for display which occurs at block 520. At block 518 the CPU is interrogated in order to determine if a comparison of an approximated result to a result not using approximations has been commanded. If so, the comparison is performed at block 522.

FIG. 11 may also be viewed as describing the embodiments including IDs, PRMs, and imbedded deterministic nodes as output to a control system. In the case of BNs, IDs and PRMs, block 502 corresponds to providing information from parent nodes to a child node. Block 504 corresponds to producing a result at the child node. Normalization may not be necessary. In the case of a PRM, block 502 corresponds to defining relations from attribute nodes in neighboring PRMs and the selected child node. Block 504 corresponds to producing the utility value at the utility node in an ID.

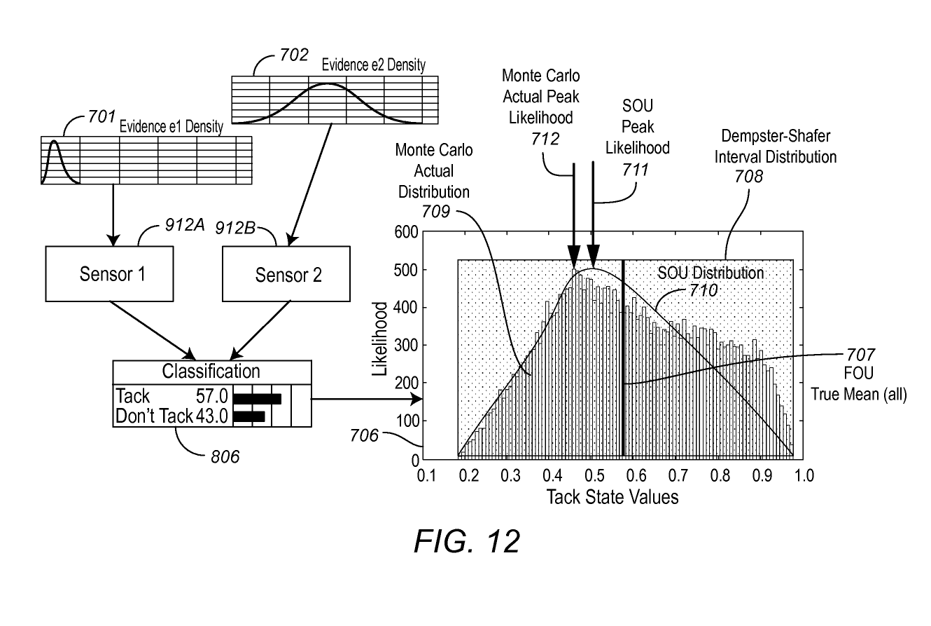

FIG. 12 illustrates the prior art interval-based propagation e.g., Dempster-Shaffer and Monte-Carlo, versus the present subject matter SOU mean/covariance propagation when using a Gaussian distribution throughout the network. The figure illustrates the disadvantage of the prior art interval methods due to loose interval bounds. As interval propagation proceeds, sizes of intervals increase, and the intervals become too broad to be helpful. An interval does not properly represent a customary distribution. The disadvantage becomes more acute when the parameters are represented by higher order distributions.

The figure represents a model of two independent sensors 912A and 912B of a process such as the sensors 912 for Wind Speed in FIG. 4, which provide information for an inference 806. The actual state distributions for the two sensors are shown as 701 and 702. The propagation through the network to the composite node 806 results in the likelihood distribution of the Tack State shown in 706. The likelihood distributions include the FOU (mean value) 707, the Dempster-Shaffer interval propagation 708, the actual distribution calculated using Monte-Carlo 709, and the SOU distribution 710 using a beta curve fit. The peak value from SOU 711 is very close to peak 712 calculated using Monte-Carlo.

While the foregoing written description of the subject matter enables one of ordinary skill to make and use what is considered presently to be the best mode thereof, those of ordinary skill will understand and appreciate the existence of variations, combinations, and equivalents of the specific embodiment, method, and examples herein. The subject matter should therefore not be limited by the above described embodiment, method, and examples, but by all embodiments and methods within the scope and spirit of the subject matter.

1. A method for encoding conditional dependencies in an inference engine comprising a network and embodying a mathematical model representing a context in which statistical methods are used as an aid in decision making in which uncertainties are propagated between one level and a next level comprising:
receiving evidence inputs at a parent node;
establishing a selected number of states for each input hypothesis;
calculating first order uncertainty of states for a given evidence input;
calculating at least one higher order statistic including at least one of standard deviation and variance for the individual states from the evidence inputs, whereby second order uncertainty (SOU) data is provided;
propagating the first order uncertainty data and the second order uncertainty data from the parent node to a child node, wherein said second order uncertainty data is used to determine a SOU inference during propagation as an input to the child node;
determining covariance of inputs to the child node;
propagating the covariance to subsequent nodes.

2. A method according to claim 1 wherein the step of propagating the covariance to subsequent nodes is continued to a utility node and providing at least one utility value.

3. A method according to claim 2 further comprising providing the at least one utility value to a utility table, and allowing selection of one said at least one utility value.

4. A method according to claim 3 comprising the step of providing the network comprising a Bayesian Network.

5. A method according to claim 3 comprising the step of providing the network comprising an Influence Diagram.

6. A method according to claim 3 comprising the step of providing the network comprising a Probabilistic Relational Model.

7. A method according to claim 3 comprising the step of providing the network comprising an output control signal.

8. A method of operating a decision support system comprising:
expressing mean values and higher order statistics for encoding conditional dependencies among variables in at least one cell of an associated Conditional Probability Table (CPT); and
using conditional dependencies, the mean values and the higher order statistics in the CPT in an inference engine through a network comprising a mathematical model of a decision process, wherein said higher order statistics are used to determine a SOU inference.

9. The method according to claim 8 wherein the method of operating a decision support system further comprises calculating mean values and higher order statistic including standard deviations for each state of a plurality of states of a potential.

10. The method according to claim 9 wherein the expressing step comprises storing mean values and deviations from the mean in at least one cell of a utility table.

11. The method according to claim 8 comprising calculating higher order statistics for each individual state in a plurality of the states from evidence inputs, whereby second order uncertainty data is provided for the individual states, and propagating the second order uncertainty data from a parent node to a child node.

12. The method according to claim 10 comprising expressing each deviation from the mean value of an individual state in terms of a positive deviation and a negative deviation.

13. A method according to claim 8 comprising the step of providing the network in the form of a Bayesian Network.

14. A method according to claim 10 including the step of providing the network in the form of an Influence Diagram.

15. A method according to claim 10 comprising the step of providing the network in the form of a Probabilistic Relational Model.

16. A method according to claim 10 comprising the step of providing the network comprising an output control signal.

17. A non-transitory machine-readable medium that provides instructions, which when executed by a processor, causes said processor to perform operations comprising:
receiving evidence inputs at a parent node;
establishing a selected number of states for each input hypothesis;
calculating first order uncertainty of states for a given evidence input;
calculating at least one higher order statistic including at least one of standard deviation and variance for the individual states from the evidence inputs, whereby second order uncertainty (SOU) data is provided;
propagating the first order uncertainty data and the second order uncertainty data from the parent node to a child node, wherein said second order uncertainty data is used to determine a SOU inference during propagation as an input to the child node;
determining covariance of inputs to the child node;
propagating the covariance to subsequent nodes.

18. A non-transitory machine-readable medium according to claim 17 further causing said processor to perform operations of propagating both mean values and covariance of potentials through the inference engine, storing CPTs and Utility Tables, and calculating mean values and higher order statistics including standard deviations of evidence obtained from interfaces.

19. A non-transitory machine-readable medium that provides instructions, which when executed by a processor, causes said processor to perform operations comprising:
expressing mean values and higher order statistics for encoding conditional dependencies among variables in at least one cell of an associated Conditional Probability Table (CPT); and
using conditional dependencies, the mean values and the higher order statistics in the CPT in an inference engine through a network comprising a mathematical model of a decision process, wherein said higher order statistics are used to determine a SOU inference.

20. The non-transitory machine readable medium according to claim 19 further comprising calculating mean values and higher order statistics including standard deviations for each of a plurality of states of a potential.

21. An inference system embodying a mathematical model representing a context, the inference system comprising:
an interface layer, a covariance layer and an inference engine:
the inference engine comprising a processor calculating both mean values and second order uncertainty (SOU) data for individual states in a plurality of evidence input states and covariance of potentials at nodes in the inference engine, the processor comprising storage for Conditional Probability Tables;
the inference engine further comprising parent and child nodes, child nodes receiving the calculated mean and the calculated second order uncertainty data for each state of a plurality of states propagating from at least one parent node, wherein said SOU data is used to determine a SOU inference;
nodes being coupled to propagate in accordance with the mathematical model to a utility node.

22. An inference system according to claim 21 further comprising a circuit resolving each range within a potential into a selected number of first order uncertainty states and wherein said processor is programmed to calculate a mean value for each state and to calculate higher order statistics including at least one of standard deviation and variance for each state of the plurality of states, whereby a second order uncertainty is provided to determine covariance of inputs to a node.

23. A method of operating a decision support system comprising:
expressing mean values and deviations from the mean for conditional dependencies in at least one cell of an associated Utility Table; and
using conditional dependencies, the mean values and the deviations from the mean in the Utility Table in an inference engine through a network comprising a mathematical model of a decision process, wherein said deviations from the mean in the Utility Table are used to determine a range of expected utility.
